(19) United States
(12) Patent Application Publication
(10) Pub. No.: US 2016/0255157 A1
(43) Pub. Date: Sep. 1, 2016

(54) INITIATING COMMUNICATION SESSION USING PREFERRED MODE OF COMMUNICATION WHILE MAINTAINING CONFIDENTIALITY

(71) Applicant: Sonim Technologies, Inc, San Mateo, CA (US)

(72) Inventor: Rama Moorthy Kuvethanda, Bangalore (IN)

(73) Assignee: Sonim Technologies, Inc

(21) Appl. No.: 14/634,420

(22) Filed: Feb. 27, 2015

(51) Int. Cl. H04L 29/08; H04L 12/58

(52) U.S. Cl. CPC H04L 67/141; H04L 51/02

(57) ABSTRACT

The embodiment herein discloses a system and method for establishing a communication session between a first client and a second client. The method includes receiving at a server a request from the first client to establish a communication with the second client, wherein the request comprises a contact item associated with said second client. Further, the method includes selecting at the server a preferred contact item from among a plurality of contact items associated with the second client, wherein the plurality of contact items are pre-stored at the server by the second client. Furthermore, the method includes attempting to initiate the communication session from the first client to the second client using the preferred contact item, wherein the preferred contact item remains confidential to the second user during the communication session.

### TECHNICAL FIELD

The present embodiment relates to communication systems and more particularly relates to a method and system of initiating a communication between users using a preferred mode of communication while maintaining confidentiality.

### BACKGROUND

In the modern world, there are multiple real time communication modes available for users to contact each other. Examples of real-time communication modes can include, but not limited to, a telephone call, a VoIP call, an SMS, an email, a pager message, messenger, Push-to-talk and so on.

To streamline the process of communication, all the multiple modes of communication available to contact a user may be stored together in the form of contact information. Based on the type of contact information, a communication can be established between a caller and a callee. To perform such a communication, the caller needs to be aware of the current contact information of the callee. Although, the contact information is available full time with users in their electronic devices, there is no guarantee that the available contact information is the current or updated contact information associated with the callee.

To ensure that current contact information is updated, users may need to manually update the contact information. Though there are multiple variants for this case, in a typical scenario this translates to contacting the user through the telephone number, which may include following challenges.

Necessity to keep the public updated with the current telephone number or real-time contact information. Exposure of current real-time contact information that could breach the privacy of the individual. Ending up with expensive communication scenarios while a cheaper alternative can be possible. No choice of altering the mode of communication than the one started by the caller.

Thus, there remains a need of a simple and robust system and method for allow a caller to contact a callee using a preferred mode of communication without disclosing the alternate contact information. This is essential to protect the privacy of the callee when required.

### OBJECT OF EMBODIMENT

The principal object of the embodiments herein is to provide a system and method for initiating a communication session between users in real-time using a preferred mode of communication without disclosing identity of a callee.

Another object of the embodiments herein is provide a mechanism for automatically establishing a communication session in real-time using a current contact item associated with a callee while maintaining confidentiality of the current contact item during the communication session.

Yet another object of the embodiments herein is to establish a communication session between users based on user availability and user preferences. Depending on the status or class of the caller, the database can decide to access or reject the request for the callee's information.

Yet, another object of the embodiments herein is to provide a mechanism for automatically selecting an economic mode of communication to reduce cost of a communication.

Yet, another object of the embodiments herein is to provide a mechanism for automatically selecting a mode of communication based on compatibility of the callee and caller electronic device features.

Yet, another object of the embodiments herein is to provide a mechanism for automatically selecting a mode of communication based on quality of service.

### SUMMARY

Accordingly the embodiments herein provide a method for establishing a communication between a first client and a second client. The method includes receiving at a server a request from the first client to establish a communication request with the second client, wherein the request comprises a contact item associated with said second client along with a set of caller side capabilities and preferences. Further, the method includes selecting at the server a preferred contact item from among a plurality of contact items associated with the second client, wherein the plurality of contact items are pre-stored at the server by the second client. Furthermore, the method includes attempting to establish the communication session from the first client to the second client using the preferred contact item, wherein the preferred contact item remains confidential to the second user during the communication session.

Accordingly the embodiments herein provide a method for initiating a communication session using an Interactive Voice Response (IVR). The method includes activating an IVR option at a server in response to receiving a call from a first client, wherein the IVR elicits the first client for an input message. Further, the method includes receiving at the server a request as the input message from the first client, wherein the request includes a contact item associated with the second client. Furthermore, the method includes selecting at the server a preferred contact item from among a plurality of contact items associated with the second client, wherein the plurality of contact items are pre-stored at the server by the second client. Furthermore, the method includes attempting to establish the communication session from the first client to the second client using the preferred contact item, wherein the preferred contact item remains confidential to the second user during the communication session.

Accordingly the embodiments herein provide a server for initiating a communication session between a first client and a second client. The server includes a contact agent configured to receive a request from the first client to establish a communication with the second client, wherein the request includes a contact item associated with the second client. Further, the contact agent is configured to select a preferred contact item from among a plurality of contact items associated with the second client, wherein the plurality of contact items is pre-stored at the server by the second client. Furthermore, the contact agent is configured to attempt to establish the communication session from the first client to the second client using the preferred contact item, wherein the preferred contact item remains confidential to the second user during the communication session.

Accordingly the embodiments herein provide a server for initiating a communication session using an Interactive Voice Response (IVR). The server includes a contact agent configured to activate an IVR option at the server in response to receiving a call from a first client, wherein the IVR elicits the first client for an input message. The server is configured to receive a request as the input message from the first client, wherein the request includes a contact item associated with the second client. Further, the contact agent is configured to select a preferred contact item from among a plurality of contact items associated with the second client, wherein the plurality of contact items is pre-stored at the server by the second client. Furthermore, the contact agent is configured to attempt to establish the communication session from the first client to the second client using the preferred contact item, wherein the preferred contact item remains confidential to the second user during the communication session.

Accordingly the embodiment provides a computer program product for initiating a communication session. The computer program product includes a computer executable program code recorded on a computer readable non-transitory storage medium. The computer executable program code when executed causes the product to receive at a server a request from a first client to establish a communication with a second client, wherein the request includes a contact item associated with the second client. Further, the computer executable program code when executed causes the product to select at the server a preferred contact item among a plurality of contact items associated with the second client at a server. Wherein the plurality of contact items is pre-stored at the server by the second client. Furthermore, the computer executable program code when executed causes the product to attempt to establish the communication session from the first client to the second client using the preferred contact item, wherein the preferred contact item remains confidential to the second user during the communication session.

Accordingly the embodiment provides a computer program product for initiating a communication session using an IVR. The computer program product includes a computer executable program code recorded on a computer readable non-transitory storage medium. The computer executable program code when executed causes the product to activate an IVR option at server in response to receiving a call from a first client, wherein the IVR elicits the first client for an input message. Further, the computer executable program code when executed causes the product to receive at the server a request as the input message from the first client, wherein the request includes a contact item associated with the second client. Furthermore, the computer executable program code when executed causes the product to select, at the server, a preferred contact item among a plurality of contact items associated with the second client at the server, wherein the plurality of contact items is pre-stored at the server by the second client. Furthermore, the computer executable program code when executed causes the product to attempt to establish the communication session from the first client to the second client using the preferred contact item, wherein the preferred contact item remains confidential to the second user during the communication session.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF FIGURES

This embodiment is illustrated in the accompanying drawings, throughout which like reference letters indicate corresponding parts in the various figures. The embodiments herein will be better understood from the following description with reference to the drawings, in which:

FIG. 1 illustrates an overview of a system used for initiating communication between a first client and a second client, according to the embodiment as disclosed herein;

FIG. 2 illustrates the various modules used by a contact agent in a server for initiating communication session, according to the embodiment as disclosed herein;

FIG. 3A shows an example illustration of contact items stored at the server for a client, according to the embodiment as disclosed herein;

FIG. 3B shows an example illustration of contact items along with preferences stored at the server for a client, according to the embodiment as disclosed herein;

FIG. 4 is a flow chart illustrating a method for initiating communication session between the first client and the second client, according to the embodiments as disclosed herein;

FIG. 5 is a flow chart illustrating a method for initialing communication session between the first client and the second client using an Interactive Voice Response (IVR), according to the embodiments as disclosed herein;

FIG. 6 is a sequence diagram illustrating generally operations performed by the first client and the server to establish communication with the second client, according to embodiments disclosed herein;

FIG. 7 is a sequence diagram illustrating generally operations performed by the first client and the server to establish communication with the second client using a Voice-over-Internet Protocol (VoIP), according to embodiments disclosed herein;

FIG. 8 is a sequence diagram illustrating generally operations performed by the first client and the server to establish communication with the second client using a Push-to-talk (PTT), according to embodiments disclosed herein;

FIG. 9 is a sequence diagram illustrating generally operations performed by the first client and the server to establish communication with the second client using a mail option, according to embodiments disclosed herein;

FIG. 10 is a sequence diagram illustrating generally operations performed by the first client and the server to establish communication with the second client using a call forwarding number, according to embodiments disclosed herein;

FIG. 11 is a sequence diagram illustrating generally operations performed by the first client and the server to establish communication with the second client using an IVR where no internet connectivity is available, according to embodiments disclosed herein;

FIG. 12 shows an example illustration of a real time communication session, according to embodiments as disclosed herein; and

FIG. 13 depicts a computing environment implementing the system and the method, in accordance with various embodiments of the present embodiment.

### DETAILED DESCRIPTION OF THE EMBODIMENT

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those of skill in the art to practice the embodiments herein. Accordingly, the examples should not be construed as limiting the scope of the embodiments herein.

Accordingly the embodiments herein achieve a method for initiating a communication between a first client and a second client. The method includes receiving at a server a request from the first client to establish a communication with the second client, wherein the request comprises a contact item associated with said second client. Further, the method includes selecting at the server a preferred contact item from among a plurality of contact items associated with the second client, wherein the plurality of contact items are pre-stored at the server by the second client. Furthermore, the method includes attempting to establish the communication session from the first client to the second client using the preferred contact item, wherein the preferred contact item remains confidential to the second user during the communication session.

Accordingly the embodiments herein achieve a method for initiating a communication session using an Interactive Voice Response (IVR). The method includes activating an IVR option at a server in response to receiving a call from a first client, wherein the IVR elicits the first client for an input message. Further, the method includes receiving at the server a request as the input message from the first client, wherein the request includes a contact item associated with the second client. Furthermore, the method includes selecting at the server a preferred contact item from among a plurality of contact items associated with the second client, wherein the plurality of contact items are pre-stored at the server by the second client. Furthermore, the method includes attempting to establish the communication session from the first client to the second client using the preferred contact item, wherein the preferred contact item remains confidential to the second user during the communication session.

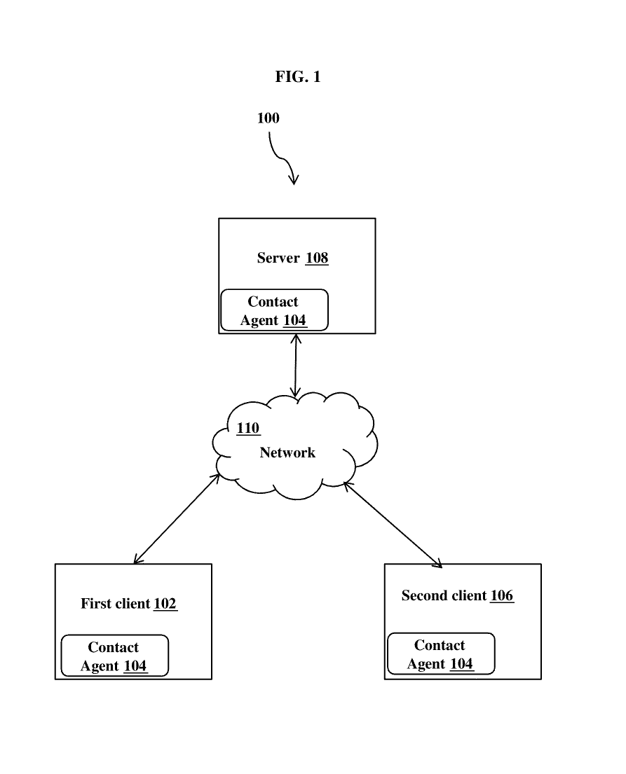

Referring now to the drawings, and more particularly to FIGS. 1 through 13, where similar reference characters denote corresponding features consistently throughout the figures, there are shown preferred embodiments.

FIG. 1 illustrates an overview of a system 100 used for initiating communication between a first client 102 and a second client 106 using a server 108, according to the embodiment as disclosed herein. The system 100 includes a contact agent 104 allowing communication between the first client 102 and the second client 106 over a communication network 110.

The first client 102 and second client described herein can be any user or subscriber along with an electronic device acting as a means for facilitating the communication among each other. Example of such electronic devices can include for example, but not limited to, a mobile phone, tablet, phablet, a personal computer, a personal digital assistance, a smart watch, a communicator, and so on. For example, when a first client initiates a communication to contact the second client, the first client act as an initiator or a caller and the second client can acts a terminator or a callee. Although the first client acts as an initiating side and the second client acts as the terminating side but, is to be other exemplary embodiments are not limited thereto. Each client can act either a callee or caller at any given time.

The server 108 described herein can be a computer including various general and special purpose modules configured to allow the communication between the first client 102 and the second client 106 using a preferred mode of communication while maintaining confidentiality. Each client registers or subscribes with the server 108. During registration, the client can update the server 108 with capabilities associated with various contact applications and the contact items. Further, these capabilities can be updated by the client as and when the capabilities change. For example, if an application used for establishing data call over the internet is removed by the client after the registration, the client can update the server 108 when communicating with the server. The server 108 can be configured to share the contact agent 104 with each registered client, such as to allow clients to communicate using a preferred mode of communication.

The contact agent 104 described herein can act as a means for the purpose of receiving or transmitting a large volume of requests from client's (102 and 106) and facilitates the communication among each other using the preferred mode of communication. Examples of, the contact agent can include for example, but not limited to, a phonebook, an address book, a contact book, and the like. In an embodiment, the contact agent 104 can be implemented using a hardware module, a software module, or a combination thereof. The contact agent 104 can be configured to communicate between the first client 102 and server 108, to establish the communication session between the first client 102 and the second client 104.

In an embodiment, the contact agent 104 at the server 108 gets updated with the client (102 and 106) capabilities while establishing a communication session. The capabilities of client's (102,106) gets updated each time the server 108 communicates with the client (102,106)

The server 108 can include a plurality of contact items which may be pre-stored at said server by the clients. The pre-stored contact items can be constantly updated by the contact agent 104 present in each client (102,104).

In an embodiment, the user may send an updated contact item to the server for storing in a database. Unlike conventional method and systems, which require the user to send his updated contact item to all the users in his contact book, the present system and method requires the user to update his contact item only at the server 108.

The server 108 can be configured to receive a request for establishing communication session from the first client to the second client 106. Based on the preferred contact item stored by the second client 106, the contact agent 104 at the server 108 can select the preferred contact item to establish communication session between the first client 102 and the second client 106.

The communication session can be an offline communication session or an online communication session. Examples of online communication session, can include, but is not limited to, a voice-over-IP call, a push-to-talk call, a video call and similar internet enabled data calls, and instant messaging service.

Examples of an online communication session, can include, but is not limited to, an electronic mail, a telephone call, a voice mail, a short message service, and a multimedia message service.

The communication network 110 described herein can include a combination of various types of networks such as, for example, but not limited to Personal Area Networks (PANs), Local Area Networks (LANs), Wide Area Networks (WANs), Global System for Mobile Communication (GSM), Internet, value-added networks, interactive television networks, wireless communications networks, two-way cable networks, satellite networks, interactive kiosk networks, cellular networks, Personal Mobile Gateways (PMGs) or any other suitable communications networks. In an embodiment, the service provider network(s) 110 can provide both a physical layer interface and a logical connection to the server 108 present in a cloud.

The FIG. 1 shows a limited overview of the system 100 but, it is to be understood that another embodiment is not limited thereto. The system 100 is only one example of a suitable environment and is not intended to suggest any limitation as to the scope of use or functionality of the embodiment. The system 100 should not be interpreted as having any dependency or requirement relating to any one or combination of components shown in the illustrative system 100 for allowing the communication session between the first client 102 and the second client 106 while without disclosing the identify. Further, the system 100 can include different modules communicating among each other along with other hardware or software components. For example, the component can be, but not limited to, a process running in the electronic device, an executable process, a thread of execution, a program, or a computer. By way of illustration, both an application running on an electronic device and the electronic device can be the component.

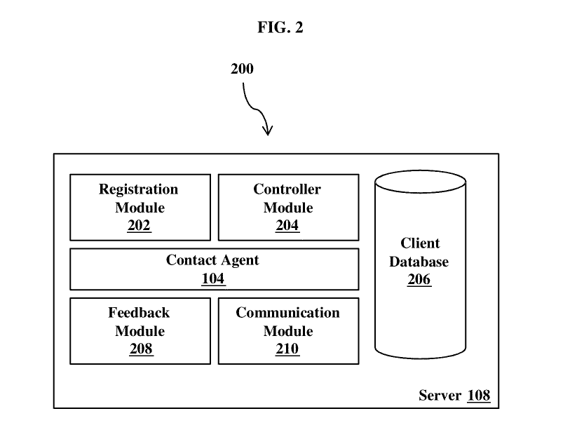

FIG. 2 illustrates the various modules 400 of the server 108 for facilitating to establish the communication session, according to the embodiment as disclosed herein. The server 108 can be configured to include a registration module 202, a controller module 204, a client database 206, a feedback module 208, and a communication module 208. The registration module 202 can be configured to allow the clients to register with the contact agent 104 at the server 108. The registered clients can establish a communication session using the contact agent 104 present in the server 108. The registration module 202 further contains security measures to ensure that the registration information of the clients (102,106) is secure.

The controller module 204 can be configured to communicate between the different modules present at the server 108. The controller module 204 includes various rules relating to the contact preferences of the client. Based on the contact preferences related to the second client, the contact agent 104 at the server can be configured to establish a communication session between the first client and the second client using a preferred contact item.

The client database 206 stores all the contact information associated with client. The contact information associated with each client is stored as a contact item. Each client (102,106) may have multiple contact items. The contact information includes the contact item and associated preferences. Further, the users of each client can configure and modify the preferences of each contact item based on their requirements. The preferences associated with each contact item can be different.

In an embodiment, the preferences and capabilities of the client (102, 104) can be dynamically updated using the contact agent 104. Examples of preference at the client (102 or 106), can include, but are not limited to, text mode as in SMS or Messaging, Voice call as in telephony call or VoIP call, and Video call. Further, the preferences can include parameters associated with the preferred mode of communication (preferred contact item), the cost associated with the mode of the communication and quality provided with the selected mode of communication. Examples of capabilities can include, but are not limited to, factors such as availability of IP (internet protocol) and associated voice or video on both ends.

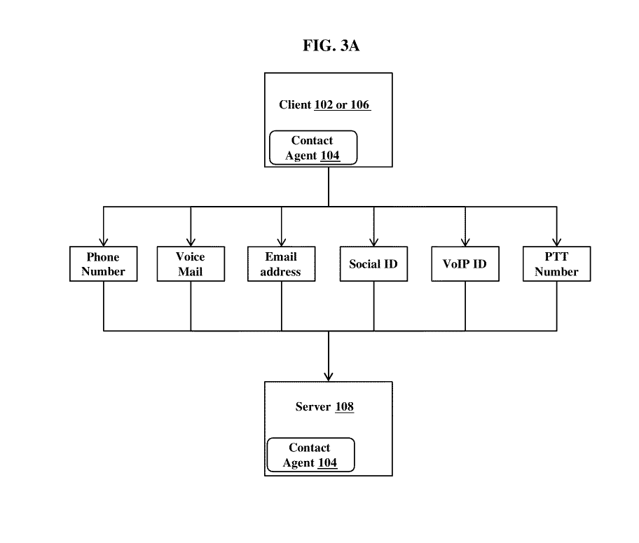

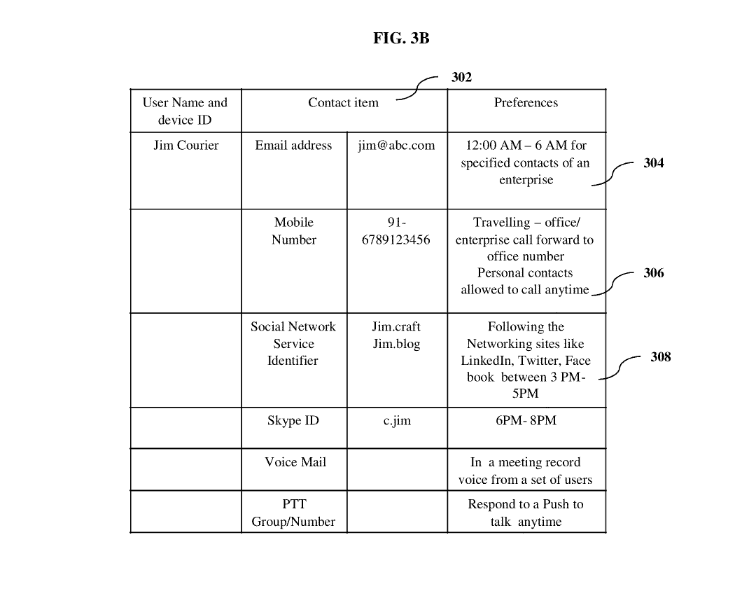

The various contact items and the preferences associated with each contact item is explained in detail in conjunction with the FIG. 3A and the FIG. 3B respectively.

The feedback module 208 can be configured to continuously receive the (QoS) Quality of Service of the communication session. Unlike conventional communication sessions, where the QoS is received at the end of each communication session, the system disclosed here allows users to switch another contact item based on the QoS during the communication session. If the user is not satisfied with the service, the contact agent 202 provides an interface to the user to switch to an alternate method of communication. Hence, the next preferred contact item of the second client 106 can be used by to establish the communication session between the first client 102 and the second client 106.

In an embodiment, when the network conditions change during the established communication session between the first client 102 and the second client 108, the server 108 can be configured to switch the communication to another contact item seamlessly between the first client 102 and the second client 108 based on the preferences and capabilities of first client 102 and the second client 108.

FIG. 3A shows an example illustration of contact items stored at the server 108 for a client (102,106), according to the embodiment as disclosed herein. Each contact item can be associated with a type of communication session. For example, when the contact item is an email address, the communication session may be in the form of an email message. Examples of contact items stored for a client (102 or 106) can include phone number, voice mail number, email address, social network service identifier, VoIP number, PPT number and so on. The contact items present at the client (102,106) gets stored at the server 108. Unlike conventional systems, where the first client needs to manually update the second client's contact item in case of change, the present embodiment uses the contact agent 104 present at server 108 to establish communication session with the second client 106 using updated contact items present in the server 108. The first client 102 may dial an old telephone number of the second client 106, and the server can select the new telephone number from the client database 206. This system and method allows the first client 102 to communicate with the second client 106 even when the second client's latest number is not available with the first client 102. Further, the cost and effort involved for the second client in informing other users of change in contact information can be avoided.

Although the FIG. 3A shows specific contact items, it must be understood that the system is not restricted to the shown contact items and contact items associated with any other type of communication mode may be stored in the server 108.

FIG. 3B shows an example illustration of contact items along with preferences stored at the server 108 for a client (102,106), according to the embodiment as disclosed herein. Furthermore, the preferences associated with each contact item can be updated by the user. For example, when expecting an important phone call from a customer (while the user is in the hospital), the user of the second client 106 may prefer to receive calls only from the customer and important family members. The user of the second client 106 can configure his preferences to receive calls from the specified contacts and divert calls from others contacts to voice mail. The FIG. 3B shows an example of preferences configured by a user called Jim courier. The contact items 302 show the different contact information present for the client (106). The email preferences 304 include receiving email between 12 AM and 6 PM from specified enterprise users. The user may prefer to communicate with the specified enterprise users over a telephone instead of email during day time.

The mobile number preferences 306 allows the user to entertain calls from a personal set of contacts at any time and the calls from another set of enterprise contacts to be forwarded to an office number. User, while travelling, can use this type of preferences. Hence, the present system and method allows the users to differentiate their personal persona and enterprise persona. Further, the user can configure the contact item 302 preferences based on his schedule.

Although the FIG. 3B shows specific preferences of client (102 or 106), it must be understood that the system is not restricted to the shown preferences and users can create multiple contact preferences based on his needs.

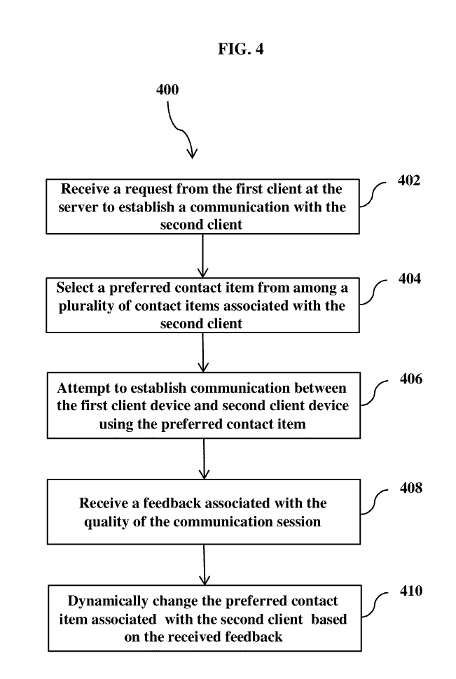

FIG. 4 is a flow chart illustrating a method 400 for initiating communication session between the first client 102 and the second client 106, according to the embodiments as disclosed herein.

At step 402, the method includes receiving at the server 108 a request from the first client 102 to establish a communication with the second client 108. The request received at the server 108 contains a contact item associated with the second client 106.

In an embodiment, the request received at the server 108 can include the first client 102's capabilities and preferences. When the user of a first client 102 chooses a contact item to communicate with the second client 106, the server 108 receives a request from the first client 102 to establish communication using the chosen contact item. The server 108 can be configured to receive a command from the first client 102.

At step 404, the method 400 includes selecting a preferred contact item at the server 108 from among a plurality of contact items associated with the second client 106. The plurality of contact items is pre-stored at the server 108 by the second client 106.

On receiving the request from the first client 104, the contact agent 104 at the server 108 can be configured to select the preferred contact item at the server 108 from among a plurality of contact items associated with the second client 106. The preferred contact item can be used to establish the communication between the first client 102 and second client. The server 108 is configured to select the preferred contact item based on the preferences and the capabilities of the first client 102 and the second client 106 respectively. Further, the contact preferred by the second client 106 can be kept confidential by the server 108.

Consider an example, when the first client 102 tries to establish a communication session using a VoIP call. At the server 108, if the second clients 106 preferred contact item is a voice call, a voice call can be established between the first client 102 and the second client 106. While establishing the voice call, the server 108 ensures that the identity of the second client 106 is not exposed to the first client 102.

Consider another example when the first client 102 has advanced capabilities and the contact item preferred by the first client 102 includes a VoIP call using an IP based application. At the server 108, based on the request received, a negotiation occurs between the capabilities and preferences of the first client 102 and the second client 106. If the second client 106 preferred contact item (preferred mode of communication) is a call and has capability to communicate using the VoIP, the server 108 can establish a communication session using VoIP between the first client 102 and the second client 106. Further, in this example it is essential that the both the client's (102,106) have the same IP based application to communicate using VoIP call.

At step 406, the method 400 includes attempting to establish communication between the first client device 102 and the second client device 106 using the preferred contact item selected by the server 108.

Once the communication session is established, the first client 102 can communicate with the second client 106. In an embodiment, when the preferred contact item associated with the client (102,106) requires a third party application, the contact agent 104 can be configured to embed the third party application to ensure that the confidentiality of the contact item associated with the second client 106 is maintained.

Further, in some embodiments, the first client 102 may also configure some preferences for communication sessions. For example, the first client 102 may configure preference for the second client 106 as follows: always use VoIP to contact the second client 106. Hence, even if the preferred contact item of the second client 106 is mobile number, the communication session between the first client 102 and the second client 106 may be established only when the second client 106 is available on the VoIP. Hence, the present system and method allows users to communicate using an economical contact item.

Consider an example, when the second client is not taking calls on his mobile number and sets the preferred contact item as Email. When the first client 102 dials the mobile number of the second client 106, the server 108 can receive the call and select the preferred contact item. The server 108 can then open an application in the first client 102 to compose an email for the second client 106. Once composed, the email can be sent to the second client 106.

At step 408, the method 400 includes receiving a feedback associated with the quality of the communication session. The server 108 includes a feedback module 208 configured to continually receive the feedback of each communication session. The controller module 204 can be configured to identify the quality of communication session using the preferred contact item used for the communication session.

At step 410, the method 400 includes dynamically changing the preferred contact item associated with the second client 106 based on the received feedback. If the quality of feedback of the communication session is poor, the controller module 204 at the server 108 can dynamically change the preferred contact item. Consider an example, when emails sent to the second client 106 are continuously resulting in delivery failure. Based on the feedback, the server 108 may request the first client 102 to communicate using the next preferred contact item.

The various actions, acts, blocks, steps, and the like in method 400 may be performed in the order presented, in a different order or simultaneously. Further, in some embodiments, some actions, acts, blocks, steps, and the like may be omitted, added, modified, skipped, and the like without departing from the scope of the embodiment.

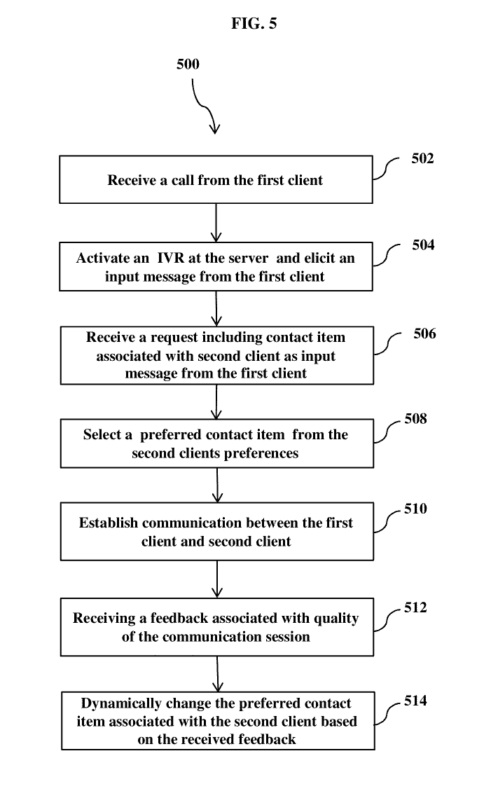

FIG. 5 is a flow chart illustrating a method 500 for establishing communication session between the first client 102 and the second client 104 using an Interactive Voice Response (IVR), according to the embodiments as disclosed herein.

At step 502, the method includes receiving at the server 108 a call from the first client 102 to establish a communication with the second client 108. In an embodiment, the server 108 may provide a toll free number to the registered subscribers when the user is not connected to Internet Protocol (IP) based network.

At step 504, the method includes activating an IVR at the server 108. The IVR may elicit the first client 102 to enter a contact item associated with the second client 106.

At step 506, the method 500 includes receiving a request including the contact item received from the first client 102 as an input message.

At step 508, the method 500 includes selecting a preferred contact item at the server 108 from among a plurality of contact items associated with the second client 106. The plurality of contact items is pre-stored at the server 108 by the second client 106. On receiving the message including the contact item of the second client 106, the contact agent 104 at the server 108 can be configured to search the contact items associated with the second client 106, and select the preferred contact item. The preferred contact item can be used to establish the communication between the first client 102 and second client 106.

The server 108 is configured to select the preferred contact item based on the preferences and the capabilities of the first client 102 and the second client 106 respectively. Further, the contact preferred by the second client 106 can be kept confidential by the server 108. Consider an example, when the first client 102 tries to establish a communication session using voice call. At the server 108, if the second clients 106 preferred contact item is voice call on a personal telephone number (not available with the first client 102), a voice call can be established between the first client 102 and the second client 106 using the personal telephone number. While establishing the voice call, the server 108 ensures that the identity of the telephone number associated with the second client 106 is kept confidential and not exposed to the first client 102.

At step 510, the method 500 includes attempting to establish communication between the first client 102 and the second client 106 using the preferred contact item selected by the server 108. The selection of the preferred contact item can be based on the preference configured by the second client 106 for each contact item, the electronic device capabilities of the first client 102, and so on.

At step 512, the method 500 includes receiving a feedback associated with the quality of the communication session. The server 108 includes a feedback module 208 configured to continually receives the feedback of each communication session. The controller module 204 can be configured to identify the quality of communication session using the preferred contact item based on the received feedback.

At step 514, the method 500 includes dynamically changing the preferred contact item associated with the second client 106 based on the received feedback. If the quality of feedback of the communication session is poor, the controller module 204 at the server 108 can dynamically change the preferred contact item.

Consider an example, when the communication to the second client 106 using a telephone number is constantly resulting in failed attempts. The present system and method allows the sever 108, based on the feedback, to establish communication using the next preferred contact item.

Consider another example, when the first client 102 needs information on contacting a service agency associated with painting works. The first client 102 contains only the Skype address of the service agency. In this case, the first client 102 can call the IVR number and receive other contact items associated with the service agency. Further, the server 108 establishes a communication session between the first client 102 and the second client 106 using the contact item preferred by the service agency.

Hence, yellow pages services can be registered with the server 108 to provide updated contact information. Once the communication session is established, the first client 102 can communicate with the second client 106.

The various actions, acts, blocks, steps, and the like in method 500 may be performed in the order presented, in a different order or simultaneously. Further, in some embodiments, some actions, acts, blocks, steps, and the like may be omitted, added, modified, skipped, and the like without departing from the scope of the embodiment.

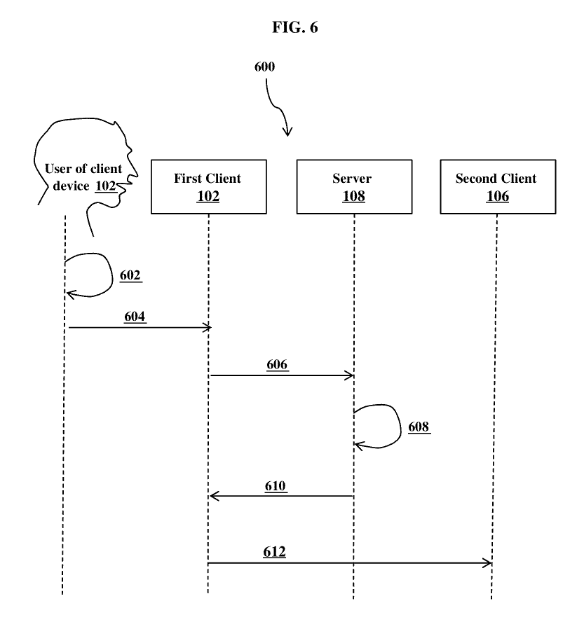

FIG. 6 is a sequence diagram 600 illustrating generally operations performed by the first client 102 and the server 108 to establish communication with the second client 104 using, according to embodiments disclosed herein. At 602, the user of the first client 102 opens an address book to establish communication with the second client 106. At 604, the user of the first client 102 selects a contact item associated with the second client 106 from the address book. The contact item may be an email address, a social ID, a VoIP ID and so on. At 606, the request for establishing communication from the first client 102 is received at the server 108 as a command. At 608, based on the contact item received in request from the first client 102, the contact agent at the server 108 can be configured to select the preferred contact item of the second client 104.

The controller module 204 can be configured to retrieve the contact items associated with the second client 106 from the client database 206. Based on the contact item preferences set by the second client 106, and the device capabilities of the first client 102, the preferred contact item can be selected by the server 108. At 608, the first client 102 receives the preferred contact item of the second client 106 from the server 108. At 610, the first client 102 can be configured to attempt to establish a communication session with the second client 106 using the preferred contact item. Once the communication session is established, the first client 102 can communicate with the second client 106.

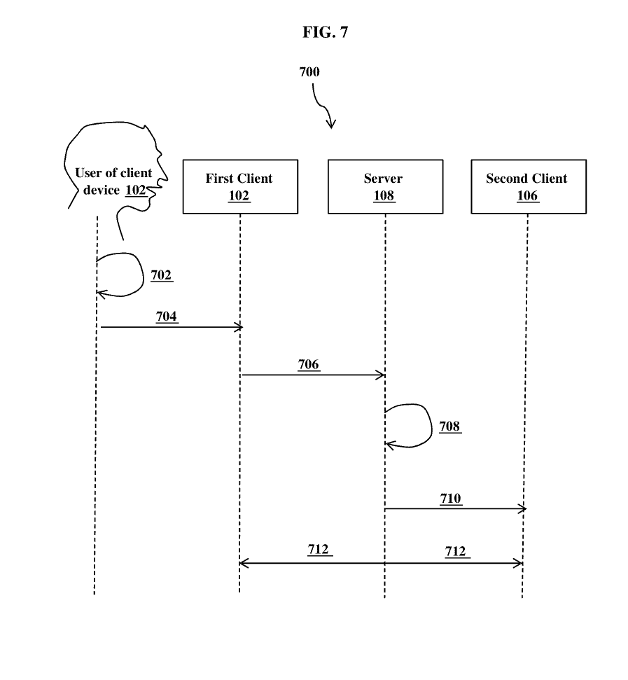

FIG. 7 is a sequence diagram 700 illustrating generally operations performed by the first client 102 and the server 108 to establish communication with the second client 104 using a Voice-over-Internet Protocol (VoIP) number, according to embodiments disclosed herein. At 702, the user of the first client 102 initiates the VoIP based calling application to establish communication with the second client 106. At 704, the user of the first client 102 selects the VoIP number associated with the second client 106 to establish a communication session. At 706, the request for establishing communication from the first client 102 is received at the server 108 as a command. At 708, based on the contact item received in the request from the first client 102, the contact agent 104 at the server 108 can be configured to select the preferred contact item of the second client 106. The controller module 204 can be configured to retrieve the contact items associated with the second client 106 from the client database 206. Based on the contact item preferences set by the second client 106, and the device capabilities of the first client 102, the preferred contact item can be selected by the server 108. In the example given in FIG. 7, the preferred contact item of the second client 106 is VoIP number. At 710, the second client 106 receives the VoIP call from the server 108 to establish communication session. At 712, the server 108 can be configured to establish a communication session between the first client 102 and the second client 106 using the VoIP number. Once the communication session is established, the first client 102 can communicate with the second client 106.

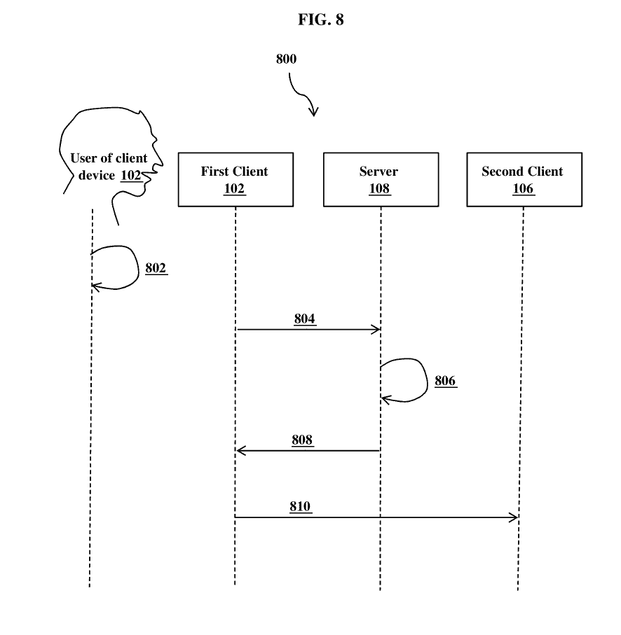

FIG. 8 is a sequence diagram 800 illustrating generally operations performed by the first client 102 and the server 108 to establish communication with the second client using a Push-to-talk (PTT) number, according to embodiments disclosed herein. At 802, the user of the first client 102 opens the address book to initiate communication with the second client 106. The user of the first client 102 selects a contact item from the address book. The contact item may be an email address, a social ID, a VoIP ID and so on. At 804, the request for initiating communication session from the first client 102 is received at the server 108 as a command.

At 806, based on the contact item received in request from the first client 102, the contact agent 104 at the server 108 can be configured to select the preferred contact item of the second client 104. The controller module 204 can be configured to retrieve the contact items associated with the second client 106 from the client database 206. Based on the contact item preferences set by the second client 106, and the device capabilities of the first client 102, the preferred contact item is selected by the server 108. In the example given in FIG. 8, the preferred contact item of the second client 106 is PTT. The server 108 is further configured to check if the first client 102 has the capability to communicate using PTT number. At 808, the first client 102 receives the PTT group or number of the second client 106 from the server 108.

At 810, the first client 102 can be configured to attempt to establish a communication session with the second client using the received PTT number. Hence, a lone worker can set PTT number as his preferred contact item. Further, the lone worker may configure the set of contacts who may communicate with him Once the communication session is established, the first client 102 can communicate with the second client 106.

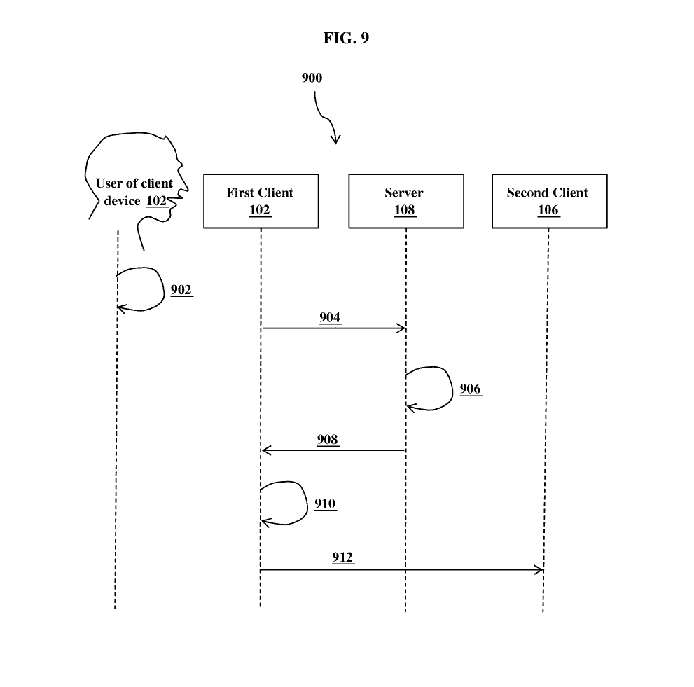

FIG. 9 is a sequence diagram 900 illustrating generally operations performed by the first client 102 and the server 108 to establish communication with the second client 106 using a mail option, according to embodiments disclosed herein. The mail option described here includes voice mail and email. At 902, the user of the first client 102 opens the address book to establish communication with the second client 106. The user of the first client 102 selects a contact item from the address book. The contact item may be an email address, a social ID, a VoIP ID and so on. At 904, the request for initiating communication from the first client 102 is received at the server 108 as a command.

At 906, based on the contact item received in request from the first client 102, the contact agent 104 at the server 108 can be configured to select the preferred contact item of the second client 104. The controller module 204 can be configured to retrieve the contact items associated with the second client 106 from the client database 206. Based on the contact item preferences set by the second client 106, and the device capabilities of the first client 102, the preferred contact item is selected by the server 108. In the example given in FIG. 9, the preferred contact item of the second client 106 can be a mail address like voice mail, email address, and so on.

At 908, the first client 102 receives a request from the server 108 to leave a voice mail or email. At 910, the contact agent in the first client 102 can be configured to establish an application associated with said preferred contact item to establish said communication session. For example, when the preferred contact item is email, the email application at the first client 102 is established. The user of the first client 102 can type in the email application. In another example, when the preferred contact item is voice mail, the user may be requested to user of the first client 102 may be requested to record a message. At 912, the first client 102 can be configured to send the mail (voice mail or email) to the second client 106. The communication session between first client 102 and the second client 106 is established and completed when the mail (voice mail or email) gets sent to the second client 106.

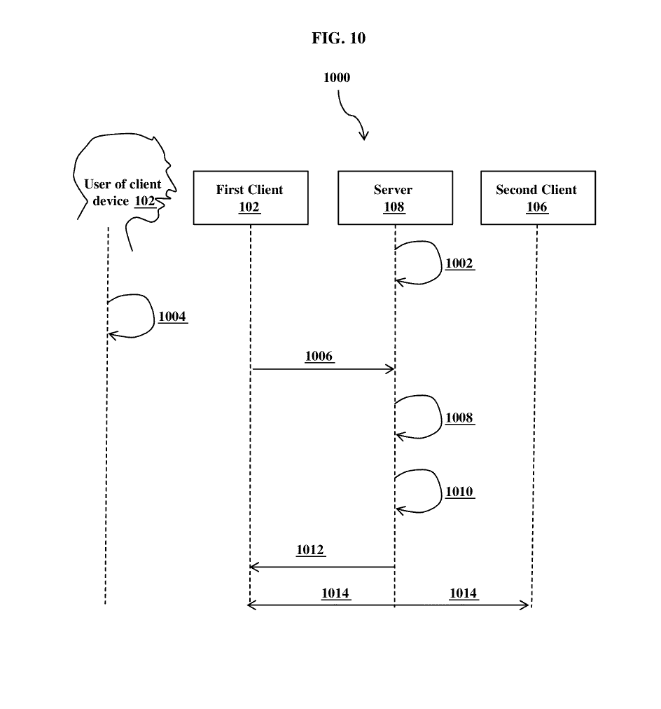

FIG. 10 is a sequence diagram 1000 illustrating generally operations performed by the first client 102 and the server 108 to establish communication with the second client 106 using a call forwarding number, according to embodiments disclosed herein. At 1002, the server 108 can be configured to update the call forwarding preferences received from the second client 104. At 1004, the user of the first client 102 opens the address book to initiate communication with the second client 106. The user of the first client 102 selects a contact item from the address book. The contact item may be an email address, a social ID, a VoIP ID and so on. At 1006, the request for initiating communication from the first client 102 is received at the server 108 as a command. At 1008, based on the contact item received in request from the first client 102, the contact agent at the server 108 can be configured to select the preferred contact item of the second client 104. The controller module 204 can be configured to retrieve the contact items associated with the second client 106 from the client database 206. Based on the contact item preferences set by the second client 106, and the device capabilities of the first client 102, the preferred contact item is selected by the server 108. In the example given in FIG. 10, the preferred contact item of the second client 106 is call forwarding. At 1010, the contact agent 104 at the server 108 can be configured to check if the first clients 102 call needs to be forwarded. At 1012, the server 108 can be configured to forward the second clients 102 call forwarding number to the first client 102. The server 108 ensures that the call forwarding number associated with the second client is kept confidential while establishing the call between the first client 102 and second client 106. At 1014, a call can be established between the first client 102 and the second client 104 using the call forwarding preferences set by the user of the second client 104. Once the communication session is established, the first client 102 can communicate with the second client 106.

For example, the second client 106 can configure the call forwarding number preferences such that all calls from the workplace get diverted to an office number and personal calls are received on the mobile number. Hence, the preferences for call forwarding provide the subscribers the benefit of selecting different contact items for different users.

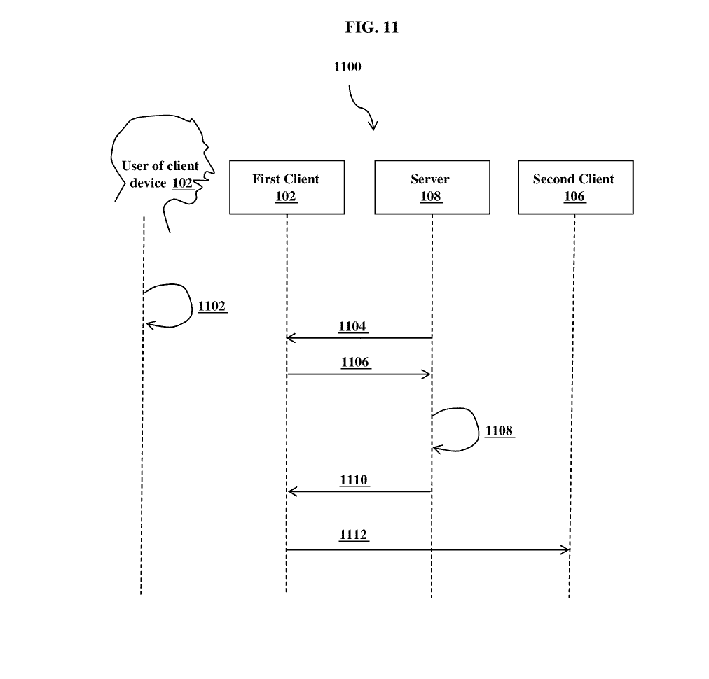

FIG. 11 is a sequence diagram 1100 illustrating generally operations performed by the first client 102 and the server 108 to establish communication with the second client 106 using an IVR, according to embodiments disclosed herein. The registered subscriber can use the IVR option when they do not have access to an IP network. Further, the IVR option can be used to receive information about the preferred contact item of the second client 106.

At 1102, the user of the first client 102 opens the address book to initiate communication with the second client 106. The user of the first client 102 selects the contact item from the address book. The contact item may be an email address, a social ID, a VoIP ID and so on.

At 1104, the server 108 can be configured to activate the IVR an IVR. The IVR can elicit the first client 102 to enter a contact item associated with the second client 106.

At 1106, the server 108 can be configured to receive the contact item provided by the first client 102 as an input message.

At 1108, based on the contact item received in the input message from the first client 102, the contact agent 104 at the server 108 can be configured to select the preferred contact item of the second client 104. The controller module 204 can be configured to retrieve the contact items associated with the second client 106 from the client database 206. Based on the contact item preferences set by the second client 106, and the device capabilities of the first client 102, the preferred contact item can be selected by the server 108.

At 1110, the first client 102 receives the preferred contact item of the second client 106 from the server 108. At 1112, the first client 102 can be configured to attempt to establish a communication session with the second client 106 using the preferred contact item. Hence the present system and method can be used by the subscribers to establish communication even when they not connected to an IP network.

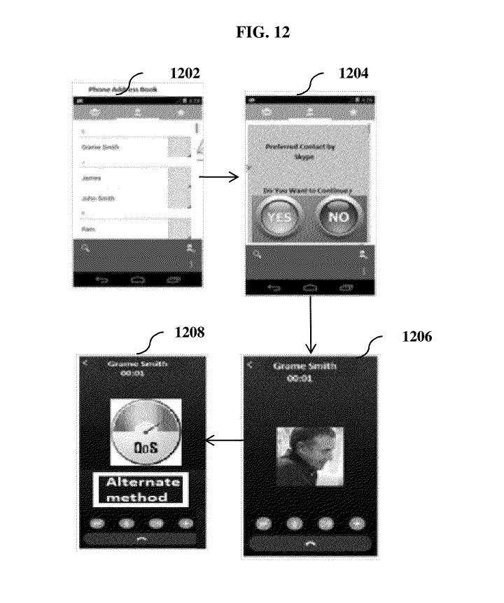

FIG. 12 shows an example illustration of a real time communication session, according to embodiments as disclosed herein. The FIG. 12 shows the user interface on the first client. 1202 contact list in a VoIP based application. 1204 shows a message from the server 108 informing the first client 102 that the second client 106 has the same VoIP based application as his preferred contact item.

The server 108 can be configured to establish the communication session between the first client 102 and the second client 104 using the contact agent 104 which has embedded the VoIP based application. 1206 shows a communication session in progress between the first client 102 and the second client 106. During the communication, the QoS of the communication session is constantly monitored. 1208 shows the level of the QoS. In an embodiment, the server 108 can be further configured to switch from the current preferred contact item to the next preferred contact item when the QoS is very poor. The user of the first client 102 may also be allowed to seek an alternate method of establishing communication if the QoS is poor.

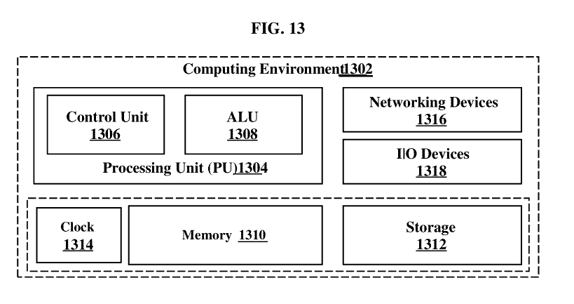

FIG. 13 depicts a computing environment implementing the method of initiating communication, in accordance with various embodiments of the present embodiment. As depicted, the computing environment 1302 comprises at least one processing unit 1304 that is equipped with a control unit 1306 and an Arithmetic Logic Unit (ALU) 1308, a memory 1310 a storage unit 1312, a clock chip 1314, plurality of networking devices 1316, and a plurality Input output (I/O) devices 1318. The processing unit 1304 is responsible for processing the instructions of the algorithm. The processing unit 1304 receives commands from the control unit 1306 in order to perform its processing. Further, any logical and arithmetic operations involved in the execution of the instructions are computed with the help of the ALU 1308.

The overall computing environment 1302 can be composed of multiple homogeneous or heterogeneous cores, multiple CPUs of different kinds, special media and other accelerators. The processing unit 1304 is responsible for processing the instructions of the algorithm. The processing unit 1304 receives commands from the control unit 1306 in order to perform its processing. Further, any logical and arithmetic operations involved in the execution of the instructions are computed with the help of the ALU 1308. Further, the plurality of process units may be located on a single chip or over multiple chips.

The algorithm comprising of instructions and codes required for the implementation are stored in either the memory unit 1310 or the storage 1312 or both. At the time of execution, the instructions may be fetched from the corresponding memory 1310 or storage 1312, and executed by the processing unit 1304. The processing unit 1304 synchronizes the operations and executes the instructions based on the timing signals generated by the clock chip 1314. The embodiments disclosed herein can be implemented through at least one software program running on at least one hardware device and performing network management functions to control the elements.

The embodiments disclosed herein can be implemented through at least one software program running on at least one hardware device and performing network management functions to control the elements. The elements, blocks, steps, acts, and operations shown in FIGS. 1 through 3 include blocks which can be at least one of a hardware device, or a combination of hardware device and software module.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

What is claimed is:

1. A method for establishing a communication session, the method comprising:
receiving at a server a request from a first client to establish a communication with a second client, wherein said request comprises a contact item associated with said second client;
selecting at said server a preferred contact item from among a plurality of contact items associated with said second client, wherein said plurality of contact items are pre-stored at said server by said second client; and
attempting to establish said communication session from said first client to said second client using said preferred contact item, wherein said preferred contact item remains confidential to said second user during said communication session.

2. The method of claim 1, wherein attempting to establish said communication session comprising automatically initiating an application associated with said preferred contact item to establish said communication session.

3. The method of claim 1, wherein said preferred contact item is selected based on at least in part a preference configured by said second client and capabilities of said first client, wherein said first client and said second client are registered with said server.

4. The method of claim 1, wherein said preferred contact item associated with said second client is dynamically changed based on a feedback associated with said communication session.

5. The method of claim 1, wherein said communication session is an offline communication session, wherein said offline communication session comprises an electronic mail, a telephone call, a voice mail, a short message service, and a multimedia message service.

6. The method of claim 1, wherein said communication session is an online communication session, wherein said online communication session comprises a voice-over-IP call, a push-to-talk call, a video call and an instant messaging service.

7. A method for establishing a communication session, the method comprising:
activating an interactive voice response (IVR) option at a server in response receiving a call from a first client, wherein said IVR elicit said first client for an input message;
receiving at said server a request as said input message from said first client to establish a communication with a second client at a server, wherein said request comprises a contact item associated with said second client;
selecting at said server a preferred contact item from among a plurality of contact items associated with said second client; wherein said plurality of contact items are pre-stored at said server by said second client; and
attempting to establish a communication session from said first client to said second client using said preferred contact item.

8. The method of claim 7, wherein attempting to establish said communication session comprising automatically initiating an application associated with said preferred contact item to establish said communication session, wherein said preferred contact item remains confidential to said second user during said communication session.

9. The method of claim 7, wherein said preferred contact is selected based on at least in part a preference configured by said second client and capabilities of said first client, wherein said second client is registered with said server.

10. The method of claim 7, wherein said preferred contact item associated with said second client is dynamically changed based on a feedback associated with said communication session.

11. A server for establish a communication session, the server comprising a contact agent configured to:
receive at a server a request from a first client to establish a communication with a second client, wherein said request comprises a contact item associated with said second client;
select at said server a preferred contact item from among a plurality of contact items associated with said second client; wherein said plurality of contact items are pre-stored at said server by said second client; and
attempt to establish a communication session from said first client to said second client using said preferred contact item, wherein said preferred contact item remains confidential to said second user during said communication session.

12. The server of claim 11, wherein attempt to establish said communication session comprises automatically initiating an application associated with said preferred contact item to establish said communication session.

13. The server of claim 11, wherein said preferred contact item is selected based on at least in part a preference configured by said second client, and capabilities of said first client, wherein said first client and said second client are registered with said server.

14. The server of claim 11, wherein said preferred contact item associated with said second client is dynamically changed based on a feedback associated with said communication session.

15. The server of claim 11, wherein said communication session is an offline communication session, wherein said offline communication session comprises an electronic mail, a telephone call, a voice mail, a short message service, and a multimedia message service.

16. The server of claim 11, wherein said communication session is an online communication session, wherein said online communication session comprises a voice-over-IP call, a push-to-talk call, a video call and an instant messaging service.

17. A server for establishing a communication session, said server comprising a contact agent configured to:
activate an interactive voice response (IVR) option at a server in response receiving a call from a first client, wherein said IVR elicit said first client for an input message;
receive a request from said first client to establish a communication with a second client at a server as said input message, wherein said request comprises a contact item associated with said second client;
select at said server a preferred contact item from among a plurality of contact items associated with said second client; wherein said plurality of contact items are pre-stored at said server by said second client; and
attempt to establish a communication session from said first client to said second client using said preferred contact item.

18. The server of claim 17, wherein attempt to establish said communication session comprising automatically initiating an application associated with said preferred contact item to establish said communication session, wherein said preferred contact item remains confidential to said second user during said communication session.

19. The server of claim 17, wherein said preferred contact item is selected based on at least in part a preference configured by said second client, and capabilities of said first client, wherein said first client and said second client are registered with said server.

20. The server of claim 17, wherein said preferred contact item associated with said second client is dynamically changed based on a feedback associated with said communication session.

21. A computer program product comprising computer executable program code recorded on a computer readable a non-transitory storage medium, said computer executable program code when executed, causing the actions including:
receiving at a server a request from a first client to establish a communication with a second client, wherein said request comprises a contact item associated with said second client;
selecting at said server a preferred contact item from among a plurality of contact items associated with said second client; wherein said plurality of contact items are pre-stored at said server by said second client; and
attempting to establish said communication session from said first client to said second client using said preferred contact item, wherein said preferred contact item remains confidential to said second user during said communication session.

22. The computer program product of claim 21, wherein attempting to establish said communication session comprising automatically initiating an application associated with said preferred contact item to establish said communication session.

23. The computer program product of claim 21, wherein said preferred contact item is selected based on at least in part a preference configured by said second client, and capabilities of said first client, wherein said second client is registered with said server.

24. The computer program product of claim 21, wherein said preferred contact item associated with said second client is dynamically changed based on a feedback associated with said communication session.

25. The computer program product of claim 21, wherein said communication session is an offline communication session, wherein said offline communication session comprises an electronic mail, a telephone call, a push-to-talk call, a voice mail, a short message service, and a multimedia message service.

26. The computer program product of claim 21, wherein said communication session is an online communication session, wherein said online communication session comprises a voice-over-IP call, a push-to-talk call, a video call and an instant messaging service.

27. A computer program product comprising computer executable program code recorded on a computer readable a non-transitory storage medium, said computer executable program code when executed, causing the actions including:
activating an interactive voice response (IVR) option at a server in response receiving a call from a first client, wherein said IVR elicit said first client for an input message;
receiving at said server a request as said input message from said first client to establish a communication with a second client at a server, wherein said request comprises a contact item associated with said second client;
selecting at said server a preferred contact item from among a plurality of contact items associated with said second client; wherein said plurality of contact items are pre-stored at said server by said second client; and
establishing a communication session from said first client to said second client using said preferred contact item.

28. The computer program product of claim 27, wherein attempting to establish said communication session comprising automatically initiating an application associated with said preferred contact item to establish said communication session, wherein said preferred contact item remains confidential to said second user during said communication session.

29. The computer program product of claim 27, wherein said preferred contact is selected based on at least in part a preference configured by said second client and capabilities of said first client, wherein said second client is registered with said server.

30. The computer program product of claim 27, wherein said preferred contact item associated with said second client is dynamically changed based on a feedback associated with said communication session.
